(19) United States
(12) Patent Application Publication
(10) Pub. No.: US 2012/0097727 A1
(43) Pub. Date: Apr. 26, 2012

(54) FASTENING TOOL FOR FASTENING MEMBERS WITH A FUEL INJECTOR

(75) Inventor: Christian Ricordi, Bourg-Les-Valence (FR)

(73) Assignee: SOCIETE DE PROSPECTION ET D'INVENTIONS TECHNIQUES SPIT, BOURG-LES-VALENCE (FR)

(21) Appl. No.: 13/380,613

(22) PCT Filed: Jun. 23, 2010
(86) PCT No.: PCT/IB2010/052871

§ 371 Date: Dec. 23, 2011

(30) Foreign Application Priority Data
Jun. 25, 2009 (FR) 0903095

(51) Int. Cl. B25C 1/18

(52) U.S. Cl. 227/9

(57) ABSTRACT

The fastening tool comprises a system for controlling the intake of a fuel into a combustion chamber, a source of fuel, a switch for igniting said fuel in said combustion chamber. A valve, normally closed, comprises an intake port arranged for communicating with said source of fuel and an exhaust port arranged for communicating with said combustion chamber. The valve is a piezoelectric injector arranged for pressurizing the fuel at the outlet thereof and thereby micronizing it.

This invention applies well to nailing machines.

This invention relates to a fastening tool for fastening members, having an internal combustion engine, with a system for controlling the intake of a fuel into a combustion chamber in said tool, said tool further comprising a fuel source, a means for igniting said fuel in said combustion chamber, said system comprising a means including a normally closed valve, with an intake port arranged for communicating with said fuel source, and an exhaust port arranged for communicating with said combustion chamber.

Patent EP 0,597,241 discloses such a tool, wherein the intake control system further comprises an electromagnet able to be energized for opening the valve and a means including an electronic circuit arranged for, under the control of the switch, controlling the electromagnet for opening said valve, in response to said switch being closed, so as to allow said fuel to flow from said source into said combustion chamber.

In fact, until today, the fuel to be used was a liquefied and pressurized gas which, in the cartridge and the valve inlet, is in a liquid phase and, at the outlet of the valve and in the combustion chamber, in a vapour phase.

With an electromagnet, the valve, a so-called solenoid valve, functions in all or nothing mode, that is either it is closed or opened. Otherwise stated, the solenoid valve delivers the dose of fuel in one shot, which is not necessarily an accuracy guarantee. Such accuracy is all the more difficult to be controlled as the response of the solenoid valve to the control of the switch occurs by means of a transient, adding more in-accuracy to its opening time. It results that operators, in order to be sure that the necessary amount of fuel is available, tend to unnecessarily increase the fuel dose, which makes that the fuel benefit is lost, which is with a same source of fuel, a cartridge, to drive a large number of fastening members.

Moreover, such an ‘overdose’ of fuel contributes to foul the fastening tool and to increase the combustion residues.

To make it short, the Applicant sought to overcome the difficulties resulting from solenoid valves in the fastening tools for fastening members, also referred to as fixing tools, and this is why they propose their invention.

To this end, this invention relates to a fastening tool for fastening members of the above described type, characterized in that the valve is a fuel injector arranged for pressurizing the fuel at the outlet thereof and thereby micronizing the latter.

It should be noticed right from the start that the best example of the injector of this invention that could be mentioned is a piezoelectric injector, with a stack of piezoelectric quartz discs constituting an electromechanical transducer.

A fastening tool for fastening members, as used herein, is a direct or indirect fastening tool. A direct fastening tool includes a nailing machine, a stapler and an indirect fastening tool includes an anchoring or fixing resin injection gun.

The advantages of the tool of this invention are numerous.

As a result of pressurizing, the fuel gets out of the injector as a very thin jet, making the combustion more efficient. The fastening tool of this invention works well both with a liquefied and pressurized gas as with a non pressurized liquid such as an alcohol, for example methanol, having the advantage of being able to used as well as a source of energy for a fuel cell. The response time of a piezoelectric injector is very short, accurate and constant. Dosing the fuel in the combustion chamber could thus be very accurate. As a result of the speed of such an injector, injecting some fuel into the combustion chamber could occur in several operations. It could even be contemplated first to use a warming up dose, followed with a main dose, and finally, a cleaning dose for burning the residues. A piezoelectric injector tool is obviously less polluting. Finally, the tool of this invention could be small and light.

Preferably, an electronic circuit is provided, arranged so as, under the control of a switch, to open the injector for at least a predetermined time interval in order to allow for said fuel to flow from said source into said combustion chamber.

This invention will be better understood by means of the following description of a preferred embodiment of the tool according to this invention, referring to the appended drawings, wherein:

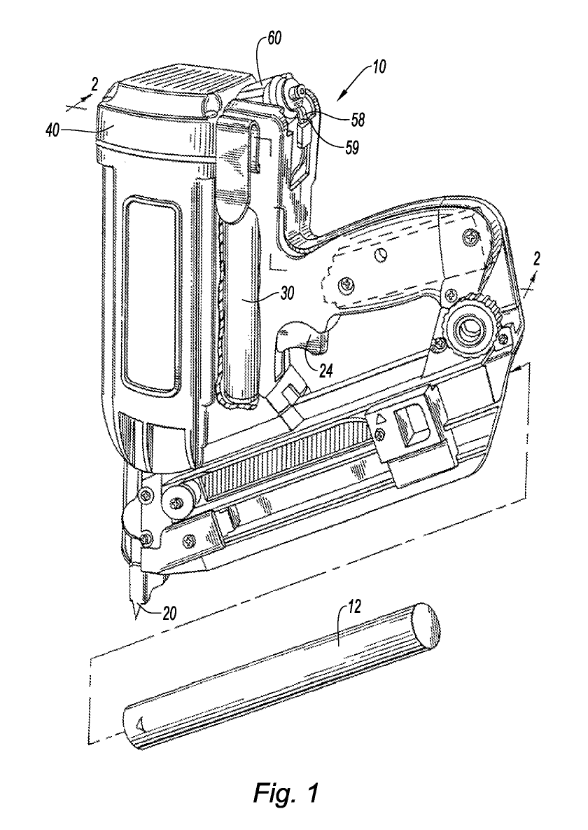

FIG. 1 is a perspective view of a fastening tool according to this invention;

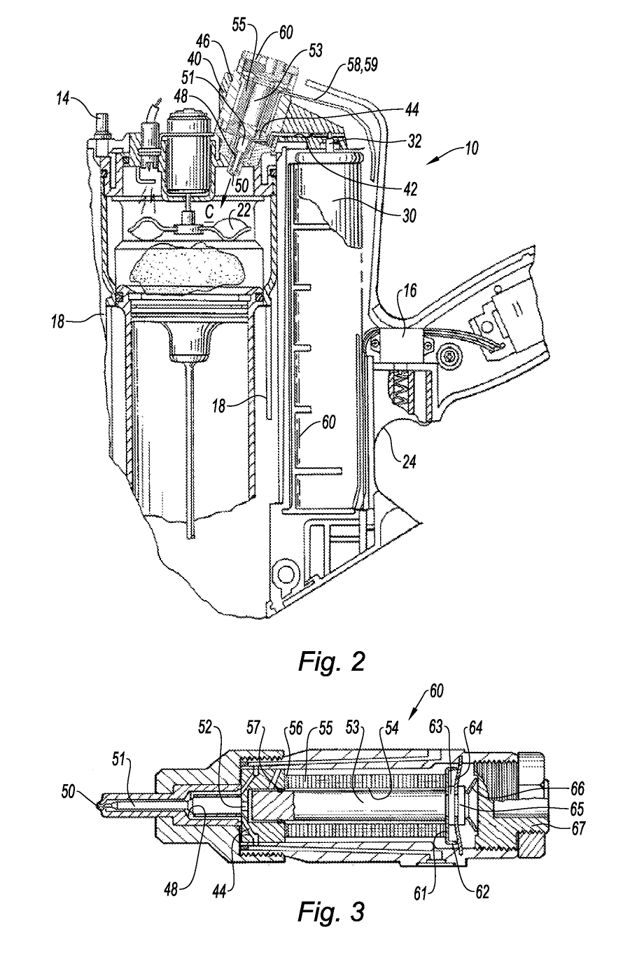

FIG. 2 is a partial longitudinal sectional view of the tool of this invention along the line 2-2 of FIGS. 1, and

FIG. 3 is an enlarged partial longitudinal sectional view of the injector of the tool of FIG. 2.

As is shown on FIGS. 1 and 2, the fastening tool 10 for internal combustion fastening members comprises a battery 12, an ignition system comprising, amongst other members, a leading switch or interrupter 14 and a triggering switch 16. Preferably, a fuel supply system cooperates with the ignition system so that fuel could flow into a combustion chamber C of the tool 10 during a predetermined time interval after the leading switch 14 has been actuated. According to another possibility, the fuel supply system cooperates with the ignition system for causing the fuel to flow, into the combustion chamber C, for a predetermined time interval after the triggering switch 16 has been triggered.

Preferably, the ignition system is similar to the ignition system described in U.S. Pat. No. 5,133,329. The leading switch 14 is normally opened and is arranged so as to be closed, as known, by a mobile member 18 of a known type, such as illustrated on FIG. 2, when a contact member 20 of the sensor, of a known type, is abutting against a support adapted to receive the fastening member. When the sensor 20 is in abutment, the mobile member 18 closes the combustion chamber C, wherein a fan 22 of a known type can be actuated. Preferably, the leading switch 14 is a photoelectric switch.

As described in U.S. Pat. No. 5,133,329, the triggering, or ignition, switch 16 should also be closed when the leading switch 14 is closed, so as to cause for the ignition system to ignite the fuel in the combustion chamber C. A manual trigger 24 is provided for closing the triggering switch 16.

In the tool 10, the fuel is here a hydrocarbon coming out in a liquid state from a pressurized cartridge 30 of a known type. The cartridge 30 has an outlet nosepiece 32, which should be pushed for allowing for the fuel to flow out of the cartridge 30 through the outlet nosepiece 32.

The tool 10 is arranged for causing the outlet nose piece 32 to be pressed when the cartridge 30 is inserted into the tool 10. Thus, the tool 10 comprises a shell 40, wherein the cartridge 30 is inserted, and having a cavity 46, the shape of which allows to provide therein a fuel injector 60, that will be described hereinunder. The shell 40 comprises a network of passage ducts 42, 44 through which the fuel hydrocarbon flows, getting out of the cartridge 30 through the outlet nosepiece 32. The outlet nosepiece 32 opens into the passage duct 42 when the cartridge 30 is inserted into the tool 10. The passage duct 44 actually extends the passage duct 42 of the shell 40 in the injector 60.

The injector 60 comprises a retaining chamber 48, into the passage ducts 44 opens, being an intake port, said chamber 48 ending with a nozzle 50, either plugged or not by a needle 51, as will be now described, the nozzle 50 constituting an exhaust port.

The nozzle 50 communicates with the combustion chamber C.

The fuel supply system comprises the fuel injector 60 provided in the cavity 46. As will be described later on, the fuel injector 60 is arranged so as to inject fuel into the combustion chamber C during a predetermined time interval for thereby controlling the volume of injected fuel. The time interval varies with the room temperature and the room pressure.

The piezoelectric injector 60, illustrated on FIG. 3 in a particular embodiment, thus comprises an inlet duct 44, an outlet nozzle 50, a retaining chamber 48, wherein the duct 44 opens into also communicating with a chamber 52 separating the top of the needle, or punch, of the injector 51 from the top of a plunger 53 arranged in the central well 54 of the stack of piezoelectric discs (quartz) 55 lying on a base 56. An annular gasket 57 surrounds the plunger 53. Electric wires 58, 59, connected to the battery 12 and to the ground, respectively, allow for a longitudinal electrical potential to be applied to both axial ends of the stack 55. Under a voltage, the stack expands in the longitudinal (axial) dimension. A washer 61, with an annular rim 62, is provided on top of the stack 55 and moves with the latter. The plunger 53 comprises a head 63 arranged between the rim washer 61 and a second arched spring washer 64 here fixed to the shell 40 of the tool. A third washer 65 is arranged between the second arched washer 64 and a fourth Belleville washer 66, the function of which is to bring the punch 51 back to the nozzle 50 in the absence of a voltage across the piezoelectric stack 55.

The arched spring washer 64 is concave towards the Belleville washer 66. When it is pushed back towards said Belleville washer, by the plunger 53, on its convex face looking at the plunger 53, it meets, at one time, an instability point and the arch thereof is inverted so as to become concave towards the plunger.

The arched washer 64 is defined to cause the possible move of the central position thereof to be substantially equal or slightly higher than the length along which the punch 51 is to be moved between its plugging position and its opening position of the nozzle 50. In the injector 60, there is provided a control screw 67 for controlling the voltage of the Belleville washer 66.

When a voltage is applied across the piezoelectric stack 55, it is submitted to a small expansion and the plunger 53, via its head 63, is driven towards to the edge of the Belleville washer 66 (to the right on FIG. 3). Such a motion of the plunger 53 causes the pressure to drop in the chamber 52, thereby creating a differential pressure on the punch 51 which, as a result, moves in the same direction as the plunger 53, into the opening position for the nozzle 50. The result thereof is a jet of fuel under pressure and micronized in the combustion chamber C.

As the section of the plunger 53, near the punch 51, is bigger than that of the punch, the moving length of the punch is bigger than that of the expansion of the piezoelectric stack 55 and of the motion of the plunger 53.

When the voltage across the piezoelectric stack 55 is cut off, it shrinks and the arched spring washer 64 is inverted so as to have a convex face towards the plunger and the punch coming back into the plugging position for the nozzle 50.

A particular piezoelectric injector has just been described. Obviously, any other piezoelectric injector is equally perfectly appropriate.

The fuel is advantageously introduced into the combustion chamber in a time controlled way, rather than in a volume controlled way. Moreover, some components are not necessary for various fuels, various conditions of room temperature or various altitudes. No mechanical force is required for fuel supply. The system could moreover comprise a means for varying the time interval in response to variations of the room temperature. The system could moreover comprise a means for varying the time interval in response to variations of the room pressure.

1. A fastening tool for fastening members, with an internal combustion engine, with a system for controlling the intake of a fuel into a combustion chamber of said tool, said tool furthermore comprising a source of fuel, a means for igniting said fuel in said combustion chamber, said system comprising a means including a normally closed valve, with an intake port arranged so as to communicate with said source of fuel, and an exhaust port arranged for communicating with said combustion chamber, characterized in that the valve is a fuel injector arranged for pressurizing the fuel at the outlet thereof and thereby micronizing it.

2. A tool according to claim 1, wherein the injector is a piezoelectric injector.

3. A tool according to claim 1, wherein there is provided an electronic circuit arranged for, under the control of a switch, opening the injector during at least one predetermined time interval, so as to allow said fuel to flow from said source into said combustion chamber.

4. A tool according to claim 1, being a tool selected in the group comprising a nailing machine, a stapler, an anchoring resin injection gun.
